(19) United States
(12) Patent Application Publication
(10) Pub. No.: US 2018/0223108 A1
(43) Pub. Date: Aug. 9, 2018

(54) DECORATIVE FILM

(71) Applicant: TOYOTA JIDOSHA KABUSHIKI KAISHA, Toyota-shi (JP)

(72) Inventors: Toshimasa HARA, Nisshin-shi (JP); Junya MURAI, Nisshin-shi (JP)

(73) Assignee: TOYOTA JIDOSHA KABUSHIKI KAISHA, Toyota-shi (JP)

(21) Appl. No.: 15/881,856

(22) Filed: Jan. 29, 2018

(30) Foreign Application Priority Data
Feb. 8, 2017 (JP) 2017-021404

(51) Int. Cl. C09D 5/33; B22F 9/24; B05D 1/00; B05D 3/02; C09D 7/61; C09D 7/40; C09D 133/10; C08J 7/04

(52) U.S. Cl. CPC C09D 5/004; B22F 9/24; B05D 1/005; B05D 3/0254; C09D 7/61; C08J 2433/10; C09D 133/10; C08J 7/047; C09D 7/68; B22F 2301/255; C08J 2300/00; C09D 7/67

(57) ABSTRACT

Provided is decorative film capable of keeping the brightness and that hardly changes in color during the continuous use. Decorative film is disposed on the surface of a resin base located in a path of a beam of a radar device. The decorative film includes: composite particles, each including a silver particle made of silver and compound including nickel and oxygen, the compound adhering to the silver particle so as to partially surround the surface of the silver particle; and light-transmissive binder resin to bind the composite particles dispersed in the decorative film. Content of the nickel is in a range of 0.5 to 30.0 mass % relative to the silver.

### CROSS REFERENCE TO RELATED APPLICATIONS

The present application claims priority from Japanese patent application JP 2017-021404 filed on Feb. 8, 2017, the content of which is hereby incorporated by reference into this application.

### BACKGROUND

### Technical Field

The present disclosure relates to decorative film formed on the surface of a resin base, the decorative film including metal particles that are bound with light-transmissive resin.

### Background Art

Some vehicles, such as automobiles, include a radar device, such as a millimeter-wave radar. Such a radar device is mounted at a front center part of the vehicle to measure the distance between the vehicle and an obstacle or another vehicle in front. The radar device emits radio waves, such as millimeter waves, and the radio waves are radiated forward through the front grille and the emblem of the vehicle manufacturer of the vehicle. The radiated radio waves are reflected from the vehicle or the obstacle in front, and the reflected waves return to the radar device via the front grille or the like.

Such a front grille or an emblem disposed along the path of a beam from the radar device is often made of a material or is coated with paint that hardly cause loss in the radio waves passing therethrough and give a desired aesthetic aspect. Typically they are made of a resin base, on the surface of which decorative film is formed.

Meanwhile silver coating film has been conventionally used in various applications because the film has high transmission for visible light and has an excellent shielding property of infrared ray. Since silver coating film has an excellent shielding property of radio waves as well, the film can protect electronic appliances, which may generate malfunction due to radio waves, from external radio waves or can suppress the radiation of radio waves from the electronic appliances or the like. Accordingly such silver coating film may be used for shielding radio waves.

For example, Japanese Patent Application Publication No. 2015-080934 A proposes decorative film including silver-alloy particles dispersed in the film and light-transmissive binder resin to bind the silver alloy particles. The silver-alloy particles included in the decorative film is an alloy of silver and nickel, and 1 to 30 mass % of nickel is contained relative to silver.

### SUMMARY

The experiment by the present inventors described below, however, shows that when the content of nickel relative to silver is large in the silver/nickel alloy of the decorative film of Japanese Patent Application Publication No. 2015-080934 A, the brightness of such decorative film significantly decreases. The experiment further shows that, when the content of nickel relative to silver for alloying is limited (decreases) to keep the brightness of the decorative film, such film easily changes in color during continuous use.

In view of these points, exemplary embodiments relate to providing decorative film capable of keeping the brightness and that hardly changes in color during the continuous use.

As a result of keen examinations, the present inventors came up with an idea that the decorative film easily changes in color at the surface of particles made of silver/nickel alloy (particles of silver alloy) because of influences from the surface plasmon. resonance absorption. Specifically as shown in FIG. 8A, when particles of silver alloy are irradiated with light, then the particles vibrate due to energy of the light, so that free electrons inside the particles move and polarization of the particles of silver alloy easily occurs.

According to this idea, as shown in FIG. 8B, surface electromagnetic waves called surface plasmon/polariton are easily generated at the surface of the silver-alloy particles so as to absorb the light with a specific wavelength, and this leads to the tendency of amplifying energy of the silver-alloy particles (surface plasmon resonance absorption). As a result, a substance around the silver-alloy particles receives the amplified energy, and so the decorative film changes in color.

Then the inventors focused on composite particles including silver particles, a part of the surface of which is surrounded with nickel compound, and silver and nickel do not form alloy so as to suppress the surface plasmon resonance absorption. The present inventors suppose that such composite particles including nickel compound surrounding the silver particles can suppress the surface plasmon resonance absorption, and so can suppress a change in quality of the binder resin and can suppress a change in color of the decorative film.

In view of the above, decorative film of the present disclosure is disposed on a surface of a resin base located in a path of a beam of a radar device, and the decorative film at least includes: composite particles, each including a silver particle made of silver and compound including nickel and oxygen, the compound adhering to the silver particle so as to partially surround the surface of the silver particle and light-transmissive binder resin to bind the composite particles dispersed in the decorative film. Content of the nickel is in a range of 0.5 to 30.0 mass % relative to the silver.

The decorative film of the present disclosure at least includes the composite particles dispersed in the decorative film and the light-transmissive binder resin to bind the dispersed composite particles, and so the decorative film can transmit radio waves and have electrical insulation properties.

In the decorative film according to the present disclosure, the composite particles are dispersed in the film, and each composite particle includes the compound of nickel and oxygen that adheres to the silver particle so as to partially surround the surface of the silver particle. This configuration can keep the brightness of the decorative film (metallic glossiness) and can suppress a change in color of the decorative film during the continuous use, as compared with the film including dispersed silver/nickel alloy.

If the composite particles contain nickel in the range of less than 0.5 mass % relative to silver, the brightness of the decorative film 1 can be kept, but the decorative film easily changes in color during the continuous use. If the composite particles contain nickel in the range of exceeding 30.0 mass % relative to silver, the brightness of the decorative film decreases, and so the metallic glossiness of the decorative film deteriorates.

In a preferable aspect, the silver particles according to the present disclosure have an average particle diameter (average primary-particle diameter) of 2 to 200 nm. Silver particles having the average particle diameter in this range easily absorb light due to the phenomenon called surface plasmon resonance absorption. The decorative film according to the present disclosure, however, includes the compound of nickel and oxygen that partially surrounds the surface of the silver particle, and this compound can suppress the absorption of light energy. Therefore the decorative film, which includes the silver particles of this size, can suppress a change in color.

If the silver particles have an average particle diameter exceeding 200 nm, diffuse reflection easily occurs on the silver particles. This results in a tendency of deterioration in silver glossiness of the film. If the silver particles have an average particle diameter less than 2 nm, the decorative film has difficulty in reflecting the light incident on the film.

The decorative film according to the present disclosure can keep the brightness and hardly changes in color during the continuous use.

### BRIEF DESCRIPTION OF THE DRAWINGS

FIG. 1 is a schematic cross-sectional view of decorative film according to one embodiment of the present disclosure;

FIG. 2 is a schematic view of the configuration of the decorative film of FIG. 1;

FIG. 3 is a schematic perspective view showing a relationship among a front grille (resin base) disposed at a front part of a vehicle, an emblem on the surface of the front grille, and a radar device disposed behind the resin base and inside the vehicle;

FIG. 4 is a schematic cross-sectional view showing a relationship among a front grille (resin base) disposed at a front part of a vehicle, an emblem on the surface of the front grille, and a radar device disposed behind the resin base and inside the vehicle;

FIG. 5 shows photographs of the distribution of silver, carbon, oxygen and nickel in the decorative film of Example 1;

FIG. 6 is a graph showing the relationship between the ratio of nickel in silver (nickel/silver) of Examples 1 to 4 and Comparative Examples 1 to 6 and the initial value of L* (before the weatherability test) of the decorative film made of such a material;

FIG. 7 is a graph showing the relationship between the ratio of nickel in silver (nickel/silver) of Examples 1 to 3 and Comparative Examples 1, 2, 4, and 5 and the color difference ΔE after the weatherability test of the decorative film made of such a material;

FIG. 8A schematically describes the polarization of silver particles with light; and

FIG. 8B schematically describes the surface plasmon resonance absorption.

### DETAILED DESCRIPTION

1. Decorative Film

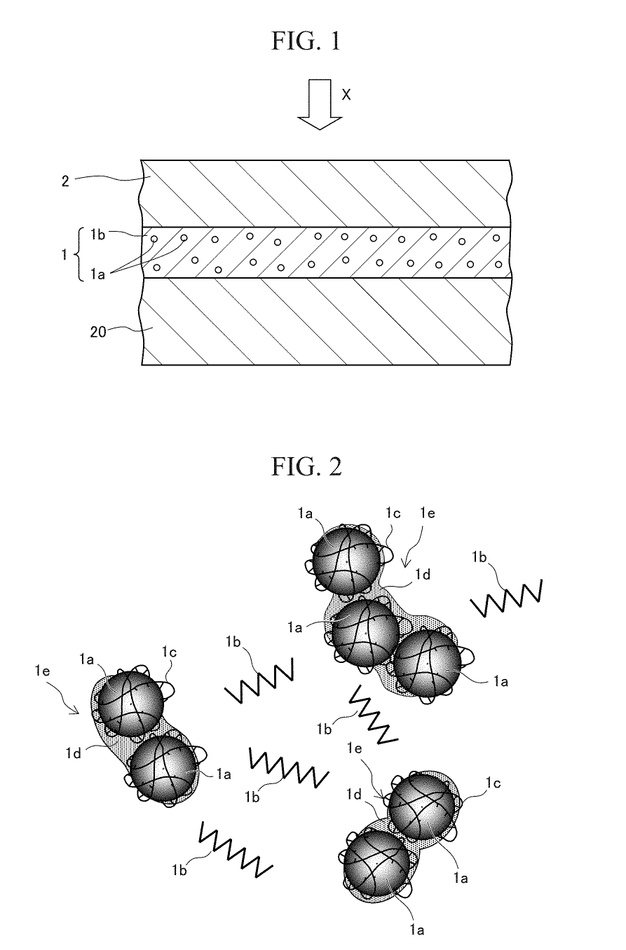

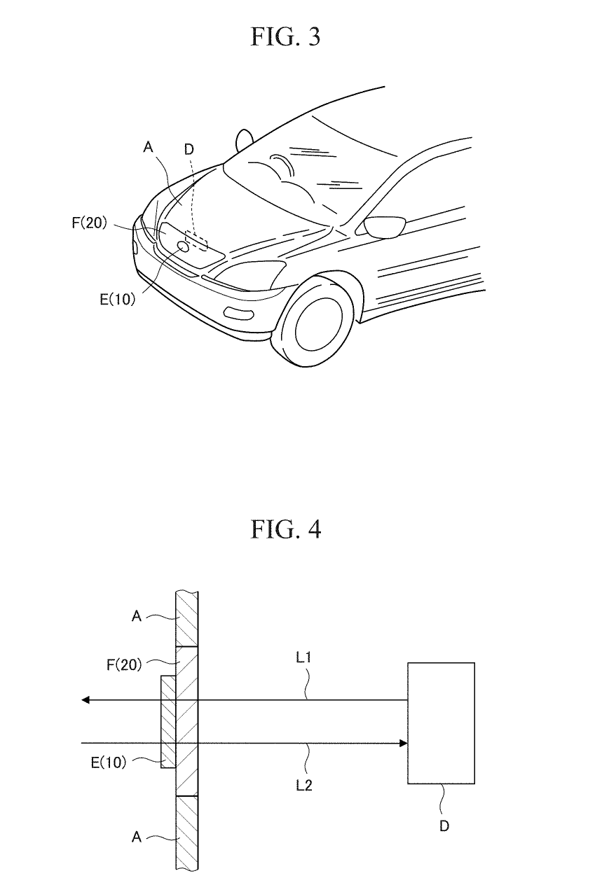

FIG. 1 is a schematic cross-sectional view of an embodiment of the decorative film of the present disclosure. FIG. 2 is a schematic view of the configuration of the decorative film of FIG. 1. FIG. 3 and FIG. 4 are a schematic perspective view and a schematic cross-sectional view, respectively, showing a relationship among a front grille (resin base) disposed at a front part of a vehicle, an emblem on the surface of the front grille, and a radar device disposed behind the resin base and inside the vehicle.

The decorative film 1 of FIG. 1 makes up the emblem to be attached to the surface of the resin base 20 as the front grille F. As shown in FIG. 3, the radar device D disposed at a front part of a vehicle body A is disposed behind the front grille F. In the present embodiment, the radar device D emits millimeter waves L1, and the millimeter waves are radiated forward through the front grille F and the emblem E on the surface of the front grille as shown in FIG. 4. The radiated millimeter waves L1 are reflected from a vehicle or an obstacle in front, and the reflected waves (millimeter waves L2) return to the radar device D via the emblem E and the front grille F. In this way, the decorative film 1 (emblem) is formed on the surface of the resin base 20 located in the path of a beam of the radar device D.

Since the decorative film 1 is applied to the surface of the resin base 20 (front grille F) located in the path of a beam from the radar device, the film has to have keep metallic glossy appearance and have the radio wave-transmitting property (electrical insulating property).

Specifically as shown in FIG. 1, a transparent resin film 2 may be stacked on the decorative film 1 in the direction from which the decorative film is seen (X direction). In this configuration, the decorative film 1 functions as a bright layer, and the resin film 2 functions as a protective layer of the decorative film 1. The resin film 2 may be made of transparent polymer resin, and may be an adhesive sheet that adheres to the decorative film 1. Alternatively, the resin film 2 may stick to the decorative film 1 via transparent adhesive, for example.

As shown in FIG. 2, the decorative film 1 includes composite particles 1e, and each composite particle includes silver particles 1a made of silver and compound 1d including nickel and oxygen, the compound adhering to the silver particles 1a so as to partially surround the surface of the silver particles 1a. These composite particles 1e are dispersed in the decorative film 1. The decorative film 1 further includes binder resin 1b to bind the composite particles 1e dispersed in the decorative film 1, and the binder resin 1b has a light-transmitting property.

Each composite particle le preferably includes a plurality of silver particles 1a that are aggregate as secondary particles while having the compound 1d including nickel and oxygen intervening between these silver particles, and the compound (substance) 1d adhere to each of the silver particles 1a so as to partially surround the surface of the silver particle 1a (see FIG. 2). Specifically the compound 1d adheres to each silver particle 1a so as to expose a part of the surface of the silver particle 1a. In this way, the compound 1d is coating to coat a part of the surface of the silver particle 1a, and may include hydrogen atoms as residue after the production, for example, at a part of the compound in addition to the nickel and oxygen. Another layer of protective agent (dispersant) 1c may be formed around the silver particle 1a. The protective agent is used as a raw material during the production of the silver particles 1a.

In addition, the composite particle 1e may include the silver particle 1a as primary particle (i.e., the silver particles 1a are separated individually), and the compound 1d including nickel and oxygen may adhere to the silver particle 1a so as to partially surround the surface of the silver particle. The compound 1d may adhere to each silver particle 1a so as to expose a part of the surface of the silver particle 1a.

In the method for manufacturing the composite particles 1e described later, the concentration of silver ions as a precursor of the silver particles 1a or the heating temperature during the production is adjusted, or the type of the protective agent 1c is selected, for example, whereby the mode of the silver particles 1a can be selected between the primary particles and the secondary particles.

The silver particles 1a of silver in the decorative film 1 are dispersed discontinuously, and the compound 1d including nickel and oxygen, the binder resin 1b and the protective agent which surround the silver particles 1a, are substances having electrical insulating properties. With this configuration, these composite particles 1e are electrically insulated from each other, and in a preferable mode, the silver particles 1a, 1a are electrically insulated from each other.

Therefore radio waves (millimeter waves) passing through the decorative film 1 hardly attenuate, and as a result, the decorative film 1 can keep metallic glossy appearance and have good millimeter-wave transmitting properties.

The “millimeter waves” used herein refer to radio waves which have a frequency band of about 30 GHz to 300 GHz, and millimeter waves can have a specific frequency hand of about 76 GHz, for example. The “decorative film” used herein refers to an element for making up the above-mentioned emblem of a vehicle manufacturer, an accessary specific to a vehicle, or the like. In a specific example, the decorative film is an emblem formed on the surface of the front grille as the resin base.

The composite particles 1e in the present embodiment contain nickel in the range of 0.5 to 30.0 mass % relative to silver. The composite particles 1e in such a range can keep the brightness of the decorative film 1 (metallic glossiness) and can suppress a change in color of the decorative film 1 during the continuous use, as compared with the film including dispersed silver/nickel alloy.

In the present embodiment, if the composite particles 1e contain nickel in the range of less than 0.5 mass % relative to silver, the brightness of the decorative film 1 can be kept, but the decorative film 1 easily changes in color during the continuous use. Note here that, as is clear from the experiment by the present inventors described later, when silver/nickel alloy particles having a similar composition ratio are used instead of the composite particles 1e in this range, such a decorative film changes in color significantly during the continuous use.

As the ratio of nickel to silver increases, the brightness of the decorative film decreases. If the composite particles 1e contain nickel in the range of exceeding 30.0 mass % relative to silver, the brightness of the decorative film 1 decreases, and so the metallic glossiness of the decorative film 1 deteriorates. Note here that, as is clear from the experiment by the present inventors described later, when silver/nickel alloy particles having a similar composition ratio are used instead of the composite particles 1e in this range, such a decorative film 1 are significantly degraded in metallic glossiness.

In the present embodiment, the silver particles desirably have an average particle diameter (average primary-particle diameter) of 2 to 200 nm. If the silver particles have an average particle diameter exceeding 200 nm, diffuse reflection easily occurs on the silver particles. This results in a tendency of deterioration in metallic glossiness of the decorative film 1. If the silver particles have an average particle diameter less than 2 nm. the decorative film 1 has difficulty in reflecting the light incident on the film.

The “particles” used herein for silver particles or composite particles refer to “nanoparticles”, and the “nanoparticles” used herein refer to particles which have an average particle diameter on the order of a few nanometers to a few hundred of nanometers. The particle diameter of nanoparticles can be measured, for example, by extracting particles present in a certain area of a FE-SEM image or TEM image of the silver particles, and finding an average of the diameters (diameter of a shape approximated as a circle) of these particles as the average particle diameter.

Silver particles typically have an average particle diameter on the order of nanometers, and so energy of the silver particles is easily amplified due to the phenomenon called surface plasmon resonance absorption. As a result, a substance around the silver particles receives the amplified energy, and so the substance easily changes in color.

In the present embodiment, however, the compound 1d including nickel and oxygen surrounds a part of the surface of the silver particles 1a having the average particle diameter in this range, and in a preferable mode, some of the silver particles 1a are aggregate via the compound 1d. This can decrease the amplified energy transmitted from the silver particles 1a to the binder resin 1b due to the surface plasmon resonance absorption. As a result, a change in color of the decorative film 1 can be suppressed.

Preferably the silver particles la have a crystallite diameter in the range of 2 to 98 nm. If the crystallite diameter is less than 2 nm, the decorative film 1 has difficulty in reflecting the light incident on the film. If the crystallite diameter exceeds 98 nm, the property of the decorative film 1 to transmit radio waves (electromagnetic waves) deteriorates.

The binder resin 1b is light-transmissive polymer resin, and has an electrical insulating property. Examples of such binder resin include acrylic resin, polycarbonate resin, polyethylene terephthalate resin, epoxy resin, and polystyrene resin.

The binder resin 1b preferably has a high affinity to the protective agent 1c as stated above. When acrylic resin having a carbonyl group is used for the protective agent 1c, the binder resin to be selected preferably is acrylic resin of the same type.

Preferably the content of the composite particles le included in the decorative film 1 as a whole is 83 to 99 mass %. If the content of the composite particles 1e is less than 83 mass % relative to the decorative film 1 as a whole, the metallic glossiness of the decorative film 1 obtained from the silver particles 1a may be not sufficient. If the content of the composite particles 1e exceeds 99 mass % relative to the binder resin 1 as a whole, adhesiveness to the resin base 20 with the binder resin 1b may be insufficient.

2. Method for Forming Decorative Film

Firstly colloid solution of the composite particles is prepared. As described above, the composite particles each include silver particles made of silver and compound including nickel and oxygen, the compound adhering to the silver particles so as to partially surround the surface of the silver particles.

These composite particles are produced by a reduction method in the liquid phase. Specifically reduction solution having a reducing ability is prepared, and protective agent (dispersant) is dissolved in this reduction solution as needed. Next nickel (specifically nickel solution) in the ionic status is added, and then silver (specifically silver solution) in the ionic status is added. As a result, silver is deposited as silver particles, and compound including nickel and oxygen adheres to the silver particles as coating so as to partially surround the surface of the silver particles.

When the protective agent is added at this time, the protective agent can control the growth rate of the silver particles, so that the average particle diameter of the silver particles can be easily adjusted. The protective agent preferably is polymer resin having good adhesiveness to silver particles and a high affinity to the binder resin that is added later.

The content of silver ions and nickel ions added is changed, whereby the composition ratio of silver and nickel constituting the composite particles can be adjusted. The average particle diameter of the silver particles can be controlled by adjusting the heating temperature and the heating time, or can be controlled by a type of the protective agent as stated above.

Next, after unreacted substance is removed from the produced colloid solution of the composite particles by filtering or the like, the resultant is substituted with appropriate solvent. Then the binder resin is added, whereby paint as a raw material as the decorative film can be obtained. This paint is applied to the resin base 20, followed by heating, whereby the decorative film 1 can be formed on the surface of the resin base 20.

### EXAMPLES

The following describes the present disclosure, by way of examples.

### Example 1

Aqueous solution containing 3.84 g of nickel nitrate was dropped to 597 g of amino alcohol as reducing agent, which was left for a while so as to disperse nickel ions in amino alcohol. Aqueous solution containing 220 g of silver nitrate dissolved into pure water was prepared. This aqueous solution was dropped to the solution containing nickel ions dispersed in amino alcohol, followed by mixing while heating at 60° C. for 120 min. Thereby silver particles were deposited, and the compound including nickel and oxygen surrounding the silver particles was deposited. In this way, the composite particles were prepared.

The prepared composite particles were UF-filtered at room temperatures for 3 hours. Thus, colloid solution of the composite particles was obtained, the composite particles containing silver particles having the average particle diameter (average primary particle diameter) of 30 nm and the compound including nickel and oxygen so as to surround the silver particles, the compound including 0.5 weight % of nickel relative to the weight of silver.

Next, compounding agent 1 was prepared by mixing 40 g of propyleneglycol monoethylether, 8.86 g of styrene, 8.27 g of ethylhexylacrylate, 15 g of lauryl methacrylate, 34.8 g of 2-hydroxyethyl methacrylate, 3.07 g of methacrylic acid, 30 g of acid phosphoxyhexamonomethacrylate, 43 g of a polymerization initiator for the propylene glycol monoethyl ether, and 0.3 g of t-butyl peroctoate.

To 0.465 g of this compounding agent 1, 0.38 g of Disperbyk 190 (manufactured by BYK Japan KK). 0.23 g of Epocros WS-300 (manufactured by NIPPON SHOKUBAI CO., LTD.), 0.09 g of BYK-330 (manufactured by BYK japan KK), and 150 g of 1-ethoxy-2-propanol were mixed to prepare paint. The paint was mixed as binder resin with the composite particles. Next, the obtained mixture was applied by spin coating and heated at 80° C. for 30 min. Thus, decorative film was formed.

### Examples 2 to 4

Similarly to Example 1, decorative film of these examples was formed. These examples were different from Example 1 in that the ratio of silver nitrate and nickel nitrate was changed in Examples 2 to 4 so that the content of nickel in the decorative film relative to silver was 1.0 mass %, 2.0 mass %, and 30.0 mass %, respectively.

### Comparative Examples 1 to 3

Similarly to Example 1, decorative film of these examples was formed. Comparative Example 1 is to show the significance of adding nickel, and Comparative Example 2 is to determine the lower limit of nickel relative to silver, Comparative Example 3 is to determine the upper limit of nickel relative to silver.

Comparative Examples 1 to 3 were different from Example 1 in that Comparative Example 1 did not include nickel nitrate and the ratio of silver nitrate and nickel nitrate was changed in Comparative Examples 2 and 3 so that the content of nickel in the decorative film relative to silver was 0.25 mass % and 35.0 mass %, respectively.

### Comparative Examples 4 to 6

Similarly to Example 1, decorative film of these examples was formed. Comparative Examples 4 to 6 were prepared for comparison between the characteristics of the decorative film as in Examples 1 to 3 including composite particles including silver and nickel that did not form alloy and the characteristics of the decorative film including silver-alloy particles including alloy of silver and nickel.

Comparative Examples 4 to 6 were different from Example 1 in that silver-alloy particles were prepared, including alloy of silver and nickel in accordance with Japanese Patent Application Publication No. 2015-080934 A, as described above. The ratio of silver and nickel in these Comparative Examples 4 to 6 was changed so that the content of nickel in the decorative film relative to silver was 0.6 mass %, 1.0 mass %, and 30.0 mass %, respectively.

[Microscopic Observation]

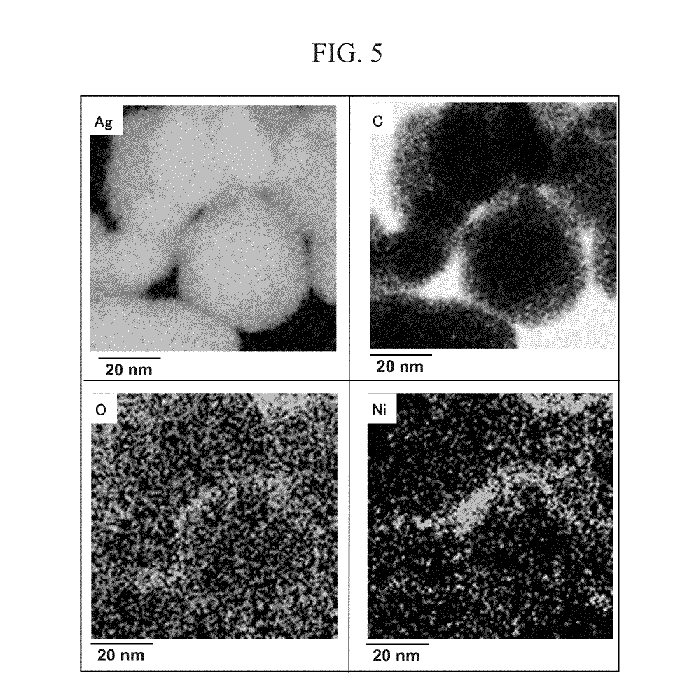

The decorative film of Example 1 was examined about the distribution of silver, carbon, oxygen and nickel with a transmission electron microscope (TEM) and by energy dispersive X-ray (EDX) spectrometry. FIG. 5 shows the result. FIG. 5 shows photographs of the distribution of silver, carbon, oxygen and nickel in the decorative film of Example 1. In FIG. 5, the left upper photo shows the distribution of silver in the decorative film, the right upper photo shows the distribution of carbon in the decorative film, the left lower photo shows the distribution of oxygen in the decorative film, and the right lower photo shows the distribution of nickel in the decorative film. White portions in the photos correspond to the elements.

[Weatherability Test (Sunshine Test)]

For weatherability test (sunshine test), the decorative film of Examples 1 to 4 and Comparative Examples 1 to 6 was exposed to light corresponding to direct sunlight under the same condition for a certain period of time. Specifically, before and after the weatherability test, the decorative film of Examples 1 to 4 and Comparative Examples 1 to 6 were measured with a color and color-difference meter (CR400, manufactured by Konica Minolta) for brightness L* and chromaticness indices a* and b* according to the color system (L*, a*, b*) specified by CIE1976 color system (JIS Z8729). Based on them, their variation width in color (color difference ΔE) was calculated.

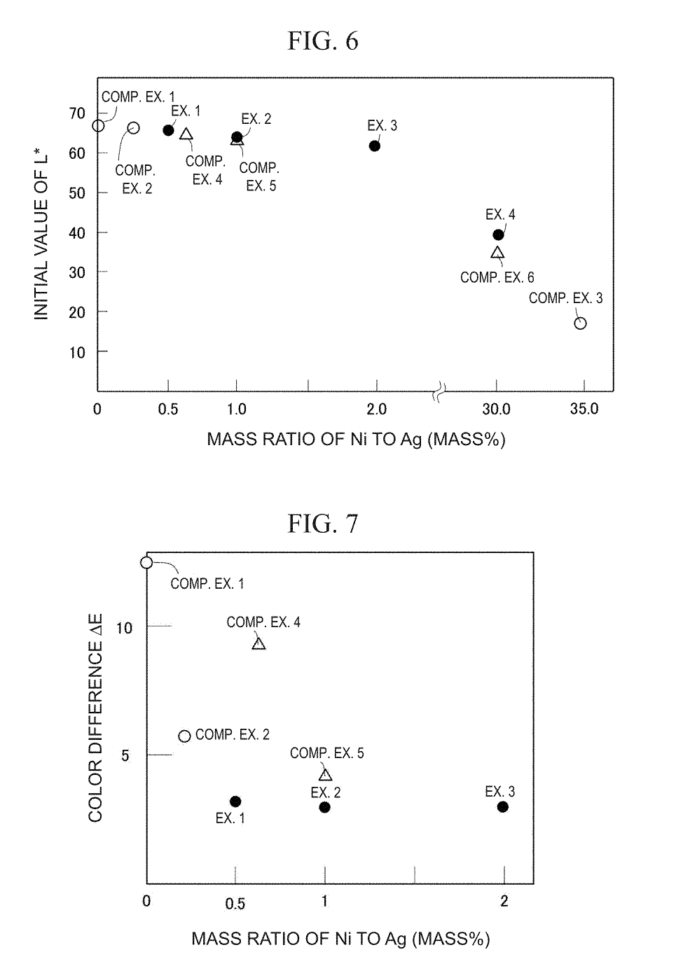

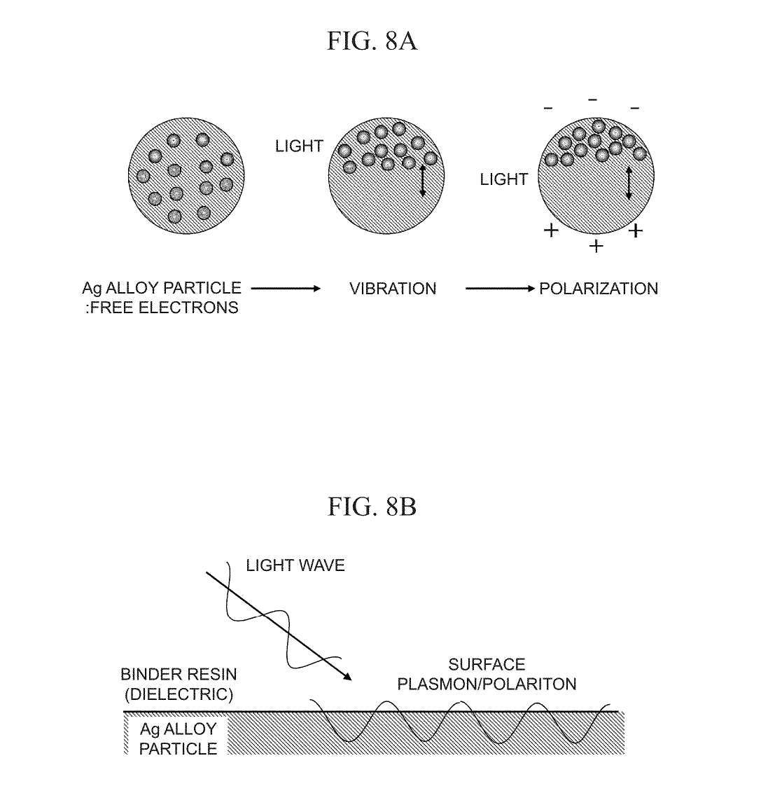

FIG. 6 is a graph showing the relationship between the ratio of nickel to silver (nickel/silver) of Examples 1 to 4 and Comparative Examples 1 to 6 and the initial value of L* (before the weatherability test) of the decorative film made of such a material. FIG. 7 is a graph showing the relationship between the ratio of nickel in silver (nickel/silver) of Examples 1 to 3 and Comparative Examples 1, 2, 4, and 5 and the color difference ΔE after the weatherability test of the decorative film made of such a material.

[Result 1: Composite Particles]

As shown in FIG. 5, the composite particles dispersed in the decorative film of Example 1 were manufactured by a method different from that for the silver-alloy particles of Comparative Examples 4 to 6. Therefore, the composite particles according to Example 1 included the compound including nickel and oxygen, the compound adhering to the silver particles so as to partially surround the surface of the silver particles made of silver.

[Result 2: Lower Limit of the Ratio of Nickel]

As shown in FIG. 6, comparison between the decorative film of Examples 1 to 3 and the decorative film of Comparative Examples 1 and 2 shows that they had similar initial values of L*. As shown in FIG. 7, however, the color difference ΔE of the decorative film of Comparative Examples 1 and 2 were larger than those of Examples 1 to 3.

Presumably this is because the decorative film of Examples 1 to 3 included more compound including nickel and oxygen surrounding the silver particles than in the decorative film of Comparative Examples 1 and 2, and so the surface plasmon resonance absorption was suppressed in these Examples between the silver particles and the binder resin. Presumably this suppressed the amount of energy that the substance surrounding the silver particles received due to continuous irradiation of light (suppressed a change in quality of the binder resin) and so suppressed a change in color of the decorative film. From this, it can be considered that the content of nickel relative to silver in the composite particles that is 0.5 mass % or more can suppress a change in color of the decorative film.

[Result 3: Upper Limit of the Ratio of Nickel]

As shown in FIG. 6, the initial values of L* of the decorative film of Examples 1 to 4 were higher than that of Comparative Example 3. Presumably the composite particles of Comparative Example 3 included more compound including nickel and oxygen surrounding the silver particles, and so the metallic glossiness of the silver particles was not obtained well. From the above, it can be considered that the content of nickel relative to silver in the composite particles that is 30.0 mass % or less can keep the brightness of the decorative film and can keep the metallic glossiness of the decorative film.

[Result 4: Silver-Alloy Particles]

As shown in FIG. 6, the initial values of L* of the decorative film of Comparative Examples 4 and 5 were substantially the same as the initial values of L* of the decorative film of Examples 1 and 2 having similar content of nickel relative to silver. As shown in FIG. 7, however, the color difference ΔE of the decorative film of Comparative Examples 4 and 5 was larger than the color difference ΔE of the decorative film of Examples 1 and 2. The particles of Comparative Examples 4 and 5 were silver-nickel alloy, and did not have the structure of the nickel/oxygen compound surrounding the silver particles. Presumably Comparative Examples 4 and 5 easily generated the surface plasmon resonance absorption due to silver alloy, and changed in color of the binder resin due to the amplified energy of light.

As shown in FIG. 6, the initial value of L* of the decorative film of Comparative Example 6 was lower than the initial value of L* of the decorative film of Example 4 having the same content of nickel relative to silver. Presumably the metallic glossiness that silver originally has was degraded because silver and nickel formed alloy.

### Example 5

Similarly to Example 1, decorative film of this example was formed. This example was different from Example 1 in heating temperature and heating time of the solution after adding silver nitrate and in that the average particle diameter of the silver particles was 200 nm. For measurement of the average particle diameter, metal particles in a certain area of a TEM image were extracted, and the average particle diameter of the silver-alloy particles was measured.

### Comparative Example 7

Similarly to Example 5, decorative film of this example was formed. This example was different from Example 5 in heating temperature and mixing time of the solution after adding silver nitrate and in that the average particle diameter of the silver particles was 500 nm.

(Result 5)

Observation of the decorative film of Example 5 and Comparative Example 7 shows that diffuse reflection from the silver particles occurred in Comparative Example 7 (the average particle diameter of the silver particles was larger than 200 nm), and metallic glossiness of the decorative film deteriorated as compared with Example 5. This shows that the average particle diameter of silver particles is preferably 200 nm or less, and the result of the crystallite diameter described later shows that the average particle diameter of silver particles is preferably 2 nm or more.

### Examples 6-1 to 6-3

Similarly to Example 1, decorative film of these examples was formed. These examples were different from Example 1 in heating temperature and heating time of the solution after adding silver nitrate and in that the crystallite diameter of the silver particles was changed to 2 nm, 25 nm and 98 nm, respectively. The crystallite diameter of the silver particles was determined by the X-ray diffraction method specified by JIS H 7805.

### Comparative Examples 8-1 to 8-2

Similarly to Example 6-1, decorative film of these examples was formed. These examples were different from Example 6-1 in heating temperature and heating time of the solution after adding silver nitrate and in that the crystallite diameter of the silver particles was changed to 1 nm and 99 nm, respectively.

(Result 6)

Observation of the decorative film of Examples 6-1 to 6-3 and Comparative Examples 8-1, 8-2 shows that the decorative film of Comparative Example 8-1 (crystallite diameter: less than 2 nm) had difficulty in reflecting the light incident on the film. The observation also shows that the decorative film of Comparative Example 8-2 (crystallite diameter: exceeding 98 nm) had difficulty in transmitting radio waves (electromagnetic waves) The decorative film of Examples 6-1 to 6-3 had metallic glossiness and had a good radio wave-transmitting properly.

While certain embodiments of the present disclosure have been described in details with reference to the drawings, the specific configuration is not limited to the above-stated embodiments, and it should be understood that the present disclosure covers design modifications without departing from the spirits of the present disclosure.

### DESCRIPTION OF SYMBOLS

1 Decorative film

1a Silver particle

1b Binder resin

1c Protective agent (dispersant)

1d Compound

1e Composite particle

2 Resin film

20 Resin base

F Front grille (resin base)

E Emblem (decorative film)

D Radar device

L1 Irradiated millimeter waves

L2 Reflected millimeter waves

What is claimed is:

1. Decorative film disposed on a surface of a resin base located in a path of a beam of a radar device, at least comprising:
composite particles, each including a silver particle made of silver and compound including nickel and oxygen, the compound adhering to the silver particle so as to partially surround the surface of the silver particle; and
light-transmissive binder resin to bind the composite particles dispersed in the decorative film, wherein
content of the nickel is in a range of 0.5 to 30.0 mass % relative to the silver.

2. The decorative film according to claim 1, wherein the silver particle has an average particle diameter of 2 to 200 nm.
